(19) United States
(12) Patent Application Publication
(10) Pub. No.: US 2026/0254604 A1
(43) Pub. Date: Aug. 27, 2026

(54) TIME DIVISION DUPLEXING IN A NON-TERRESTRIAL NETWORK

(71) Applicant: QUALCOMM Incorporated, San Diego, CA (US)

(72) Inventors: Lianghai JI, San Diego, CA (US); Alberto RICO ALVARINO, San Diego, CA (US); Qiang WU, San Diego, CA (US); Mehmet Izzet GURELLI, San Diego, CA (US)

(21) Appl. No.: 19/065,879

(22) Filed: Feb. 27, 2025

(51) Int. Cl. H04L 5/14; H04W 72/0446; H04W 84/06

(52) U.S. Cl. CPC H04L 5/14; H04W 72/0446; H04W 84/06

(57) ABSTRACT

Various aspects of the present disclosure generally relate to wireless communication. In some aspects, a user equipment (UE) may receive information that is associated with a set of time division duplex (TDD) patterns that are associated with communicating in a non-terrestrial network (NTN). The UE may communicate in the NTN based at least in part on using two or more TDD patterns in the set of TDD patterns in a sequential manner. Numerous other aspects are described.

### FIELD OF THE DISCLOSURE

Aspects of the present disclosure generally relate to wireless communication and specifically relate to techniques, apparatuses, and methods associated with time division duplexing in a non-terrestrial network.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A non-terrestrial network (NTN) may provide wireless access and/or service coverage to a user equipment (UE) in areas in which terrestrial cellular service is unavailable and/or difficult to reach, such as a mountain top, a body of water, and/or a canyon. As one example of an NTN service coverage area, a satellite may provide a coverage area to a UE. In some cases, the satellite may communicate with the UE as a transparent satellite that relays communications from a gateway or may include base station functionality and communicate with the UE as a regenerative satellite.

### SUMMARY

Some aspects described herein relate to a method of wireless communication performed by a user equipment (UE). The method may include receiving information that is associated with a set of time division duplex (TDD) patterns that are associated with communicating in a non-terrestrial network (NTN). The method may include communicating in the NTN based at least in part on using two or more TDD patterns in the set of TDD patterns in a sequential manner.

Some aspects described herein relate to a method of wireless communication performed by a network node. The method may include transmitting information that is associated with a set of TDD patterns that are associated with communicating in an NTN. The method may include communicating in the NTN based at least in part on using two or more TDD patterns in the set of TDD patterns in a sequential manner.

Some aspects described herein relate to an apparatus for wireless communication at a UE. The apparatus may include one or more memories and one or more processors coupled to the one or more memories. The one or more processors may be configured to receive information that is associated with a set of TDD patterns that are associated with communicating in an NTN. The one or more processors may be configured to communicate in the NTN based at least in part on using two or more TDD patterns in the set of TDD patterns in a sequential manner.

Some aspects described herein relate to an apparatus for wireless communication at a network node. The apparatus may include one or more memories and one or more processors coupled to the one or more memories. The one or more processors may be configured to transmit information that is associated with a set of TDD patterns that are associated with communicating in an NTN. The one or more processors may be configured to communicate in the NTN based at least in part on using two or more TDD patterns in the set of TDD patterns in a sequential manner.

Some aspects described herein relate to a non-transitory computer-readable medium that stores a set of instructions for wireless communication by a UE. The set of instructions, when executed by one or more processors of the UE, may cause the UE to receive information that is associated with a set of TDD patterns that are associated with communicating in an NTN. The set of instructions, when executed by one or more processors of the UE, may cause the UE to communicate in the NTN based at least in part on using two or more TDD patterns in the set of TDD patterns in a sequential manner.

Some aspects described herein relate to a non-transitory computer-readable medium that stores a set of instructions for wireless communication by a network node. The set of instructions, when executed by one or more processors of the network node, may cause the network node to transmit information that is associated with a set of TDD patterns that are associated with communicating in an NTN. The set of instructions, when executed by one or more processors of the network node, may cause the network node to communicate in the NTN based at least in part on using two or more TDD patterns in the set of TDD patterns in a sequential manner.

Some aspects described herein relate to an apparatus for wireless communication. The apparatus may include means for receiving information that is associated with a set of TDD patterns that are associated with communicating in an NTN. The apparatus may include means for communicating in the NTN based at least in part on using two or more TDD patterns in the set of TDD patterns in a sequential manner.

Some aspects described herein relate to an apparatus for wireless communication. The apparatus may include means for transmitting information that is associated with a set of TDD patterns that are associated with communicating in an NTN. The apparatus may include means for communicating in the NTN based at least in part on using two or more TDD patterns in the set of TDD patterns in a sequential manner.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a regenerative satellite deployment and an example of a transparent satellite deployment in a non-terrestrial network (NTN).

FIG. 4 is a diagram illustrating an example of mobility in an NTN, in accordance with the present disclosure.

FIG. 5 is a diagram illustrating a first example of a time division duplex pattern and a second example of time delay variations, in accordance with the present disclosure.

FIG. 6 is a diagram illustrating an example of a wireless communication process between a network node and a user equipment (UE), in accordance with the present disclosure.

FIG. 7 is a diagram illustrating an example process performed, for example, at a UE or an apparatus of a UE, in accordance with the present disclosure.

FIG. 8 is a diagram illustrating an example process performed, for example, at a network node or an apparatus of a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A non-terrestrial network (NTN) may provide wireless access and/or service coverage to a user equipment (UE) in areas in which terrestrial cellular service is unavailable and/or difficult to reach, such as a mountain top, a body of water, and/or a canyon. As one example of an NTN service coverage area, a satellite may provide a coverage area to a UE. In some cases, the satellite may communicate with the UE as a transparent satellite that relays communications from a gateway or may include base station functionality and communicate with the UE as a regenerative satellite. In some cases, the satellite may change locations, resulting in changes to how the satellite provides the coverage area. For instance, the satellite may operate at a first location using a first beam that is associated with a first elevation angle. Based at least in part on moving to a second location, the satellite may communicate with the UE using a second beam that is associated with a second elevation angle.

Relative to communicating with a terrestrial network node, the UE may experience and/or observe larger signal propagation delays and/or Doppler effects in wireless communications with the satellite. As an example, the satellite may operate at a 600 kilometer (km) altitude and may provide communications at the 600 km altitude based at least in part on using a 25° minimal elevation angle (MEA) for beamformed communications. In such an operating scenario, the UE may experience and/or observe different service link delay values in transmissions that are associated with the satellite. To illustrate, the UE may observe a first delay that is associated with the satellite operating at the first location, a second delay that is associated with the satellite operating at the second location, and a third delay value that is associated with the satellite operating at the third location. Accordingly, the UE 120 may observe variations in a service link delay while communicating with the satellite as the satellite changes locations and/or uses a different beam to communicate with the UE.

Wireless communication devices operating in an NTN, such as a satellite and/or a UE, may use frequency division duplexing (FDD) to communicate with one another and/or may use FDD bands that are specified by an overseeing organization. To support FDD, a wireless communication device may include a duplexer that provides isolation between a transmitter and a receiver such that the wireless communication device may transmit and receive simultaneously (e.g., via different frequencies). Using the duplexer may provide simultaneous transmission and reception at the tradeoff of increased expense, increased size, and/or increased implementation complexity (e.g., thermal management, narrower filter designs, insertion loss management, and/or signal degradation management). As an alternative to using FDD, wireless communication devices operating in an NTN may use a time division duplex (TDD) mode to communicate with one another.

As part of TDD communications, different time partitions of a frequency resource may be assigned to respective communications. For instance, a TDD pattern may span a time partition (e.g., a slot or a mini-slot), and the time partition may be divided into multiple sub-time partitions (e.g., symbols). The sub-time partitions may be assigned to downlink communications, uplink communications, and/or flexible communications. That is, the sub-time partitions of the time partition may be assigned to different combinations of communication types, such as a first set of sub-time partitions being assigned to downlink communications, a second set of sub-time partitions being assigned to uplink communications, and a third set of sub-time partitions being assigned to flexible communications to form a TDD pattern.

In a terrestrial network (TN), a UE and a network node may have a similar timing relationship (e.g., synchronized to within a threshold) between downlink time partitions and uplink time partitions such that a TDD pattern may be configured to avoid a downlink sub-time partition overlapping with an uplink sub-time partition at both the UE and the network node. In an NTN system, the UE and/or the network node may observe larger propagation delays relative to propagation delays associated with TN communications based at least in part on the larger distance between a network node (e.g., a satellite), and the larger propagation delays may result in the UE and the network node having different timing relationships that are less synchronized.

An NTN network node, such as a satellite, may communicate with multiple UEs using a same TDD pattern, also referred to as a common TDD pattern. Each UE may compute a respective latency that is associated with a respective propagation delay for communications with the NTN network. In some cases, the variations in delays between the different UEs may result in a downlink communication by the satellite at least partially overlapping with an uplink communication by one or more UEs.

To mitigate overlaps between downlink communications and uplink communications in an NTN, a network node (e.g., a satellite, a ground station, and/or a terrestrial network node) may determine to change a TDD pattern (e.g., a common TDD pattern) that is used to communicate with a UE. For instance, a network node may broadcast an indication of a TDD pattern and/or a change to a common TDD pattern in a system information block (SIB). Alternatively, or additionally, the network node may trigger a UE to perform a system information (SI) update procedure to read the SIB to obtain the change to the common TDD pattern. However, using an SI update procedure to trigger the UE to update a TDD pattern may result in ambiguities, resource waste, and/or increased power consumption at a UE. For instance, the network node that triggers the SI update procedure may not receive confirmation from the UE that indicates the UE has successfully received the SIB and/or has successfully applied the updated TDD pattern. Accordingly, the network node may refrain from assigning resources to the UE during a SIB modification period, potentially resulting in air interface resources being unused and/or wasted. As another example, triggering an SI update procedure for each update to a TDD pattern may increase how often the UE receives and decodes the SIB to obtain updated TDD pattern information, resulting in increased power consumption at the UE and/or increased signaling overhead in the NTN that results in fewer resources being available for data traffic. Resource waste and the increased signaling overhead may lead to increased data transfer latencies and reduced data throughput in a wireless network. Alternatively, or additionally, increased power consumption at a UE may reduce an operating duration of the UE.

Various aspects relate generally to TDD in an NTN. Some aspects more specifically relate to a network node and/or a UE using a set of TDD patterns in a sequential manner. In some aspects, a UE may receive information that is associated with a set of TDD patterns that are associated with communicating in an NTN. As one example, the UE may receive an indication of a set of TDD patterns in a SIB. As another example, the UE may receive an indication of multiple radio resource control (RRC) configured TDD patterns in Layer 3 signaling, and selection of one or more particular TDD patterns (e.g., from the multiple RRC configured TDD patterns) in Layer 1 signaling and/or Layer 2 signaling. Based at least in part on receiving the information, the UE may communicate in the NTN based at least in part on using two or more TDD patterns in the set of TDD patterns in a sequential manner.

In some aspects, a network node may transmit information that is associated with a set of TDD patterns that are associated with communicating in an NTN. For instance, the network node may be a satellite that provides wireless access to a network, and the satellite may transmit an indication of the set of TDD patterns in a SIB as described below. Based at least in part on transmitting the information, the network node may communicate in the NTN based at least in part on using two or more TDD patterns in the set of TDD patterns in a sequential manner.

Particular aspects of the subject matter described in this disclosure can be implemented to realize one or more of the following potential advantages. In some examples, by indicating information that may be used to obtain and/or derive a set of TDD, the described techniques can be used to enable a network node and a UE to communicate in an NTN in a manner that mitigates resource waste, increased overhead signaling, and/or increased power consumption at a UE. For instance, the network node may indicate the set of TDD patterns in a single SIB to reduce signaling overhead, and the network node and/or the UE may sequentially apply two or more of the TDD patterns in the set in a coordinated manner (e.g., without additional signaling overhead). In some aspects, each TDD pattern in the set of TDD patterns may be associated with a respective application time such that the network node may assume when the UE will switch a TDD pattern, thus enabling the network node to allocate air interface resources that might otherwise not be used, which may result in reduced resource waste. In some aspects, the network node and the UE may switch the applied TDD pattern used to communicate with one another in a coordinated and simultaneous manner (e.g., without additional signaling overhead).

The use of a set of TDD patterns may also reduce how often the network node triggers an SI update procedure at the UE, thus reducing how often the UE receives and decodes the SIB to obtain updated TDD pattern information, and decreasing power consumption at the UE. Reducing resource waste and signaling overhead may lead to decreased data transfer latencies and increased data throughput in a wireless network. Alternatively, or additionally, decreasing power consumption at a UE may extend an operating duration of the UE.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, NTN deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

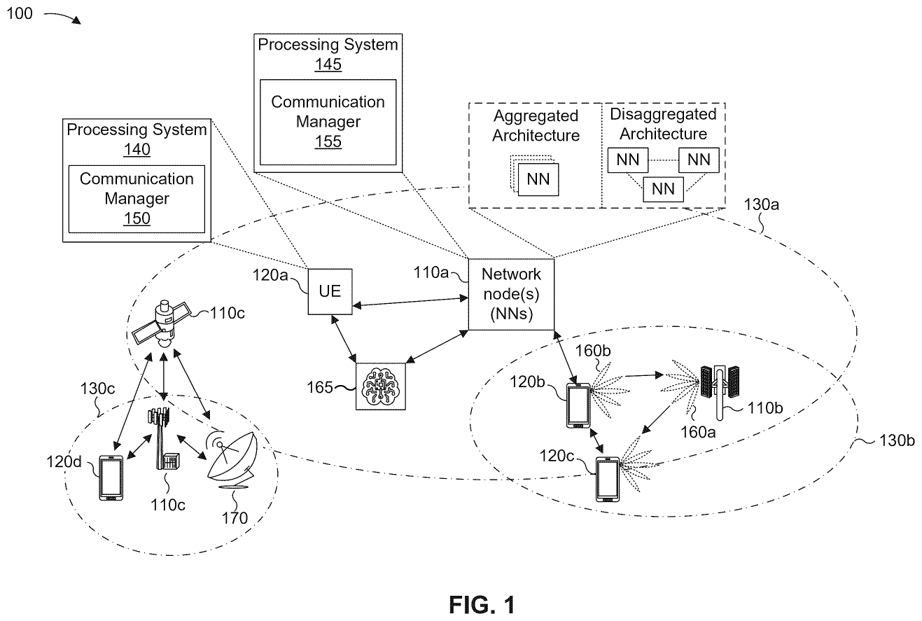

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR 1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

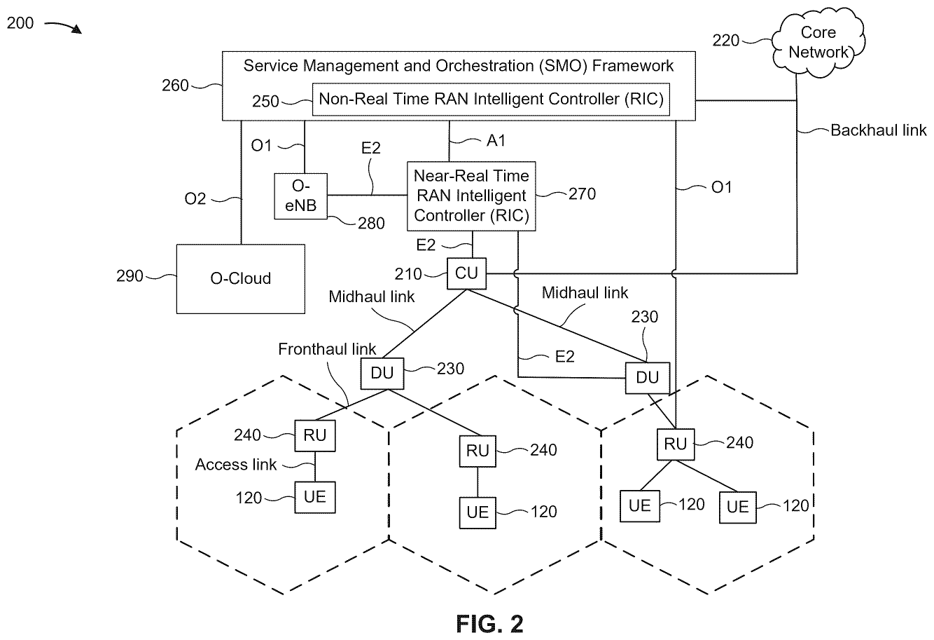

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

As indicated above, a network node 110 may be a terrestrial network node 110 (for example, a terrestrial base station or entity of a disaggregated base station) or an NTN network node 110. In the example shown in FIG. 1, the network node 110c may be an NTN network node 110 and the cell 130c may be an NTN cell. For example, the wireless communication network 100 may include one or more NTN deployments including an NTN network node 110 and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120 (e.g., the UE 120d), other NTN network nodes 110 in the one or more NTN deployments, other types of network nodes 110 (for example, stationary, terrestrial, and/or ground-based network nodes, such as the network node 110c), relay stations, and/or one or more components and/or devices included in or coupled with a core network of the wireless communication network 100. For example, an NTN network node 110 may communicate with a UE 120 via a service link (for example, where the service link includes an access link). Additionally or alternatively, an NTN network node 110 may communicate with a gateway 170 (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). In some examples, an NTN deployment may be transparent (for example, where the NTN network node 110 operates in a similar manner as a repeater or relay and/or where an access link does not terminate at the NTN network node 110). In some other examples, an NTN deployment may be regenerative. For example, an access link may terminate at the NTN network node 110, and the NTN network node 110 may regenerate a signal (such as by performing signal processing or enhancement, which may include error correction, modulation or demodulation, or amplification).

In some aspects, a UE (e.g., a UE 120) may include a communication manager 150. As described in more detail elsewhere herein, the communication manager 150 may receive information that is associated with a set of TDD patterns that are associated with communicating in an NTN; and communicate in the NTN based at least in part on using two or more TDD patterns in the set of TDD patterns in a sequential manner. Additionally, or alternatively, the communication manager 150 may perform one or more other operations described herein.

In some aspects, a network node (e.g., a network node 110) may include a communication manager 155. As described in more detail elsewhere herein, the communication manager 155 may transmit information that is associated with a set of TDD patterns that are associated with communicating in an NTN; and communicate in the NTN based at least in part on using two or more TDD patterns in the set of TDD patterns in a sequential manner. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

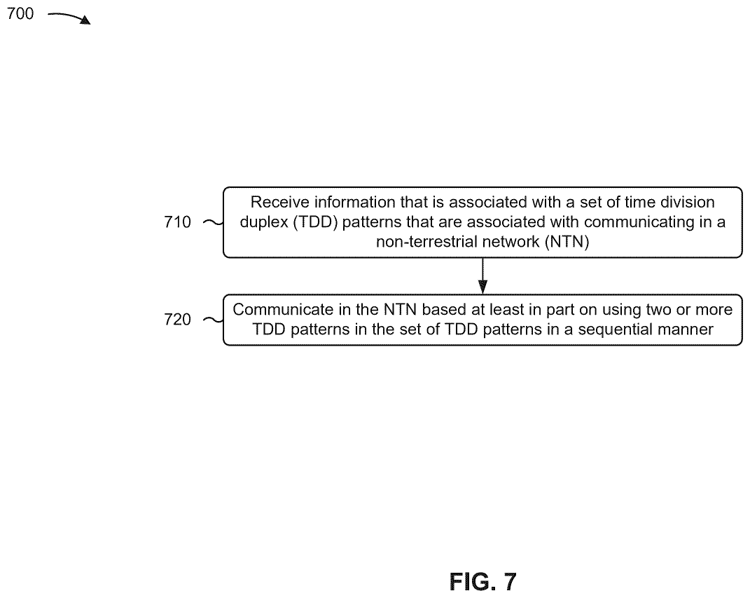

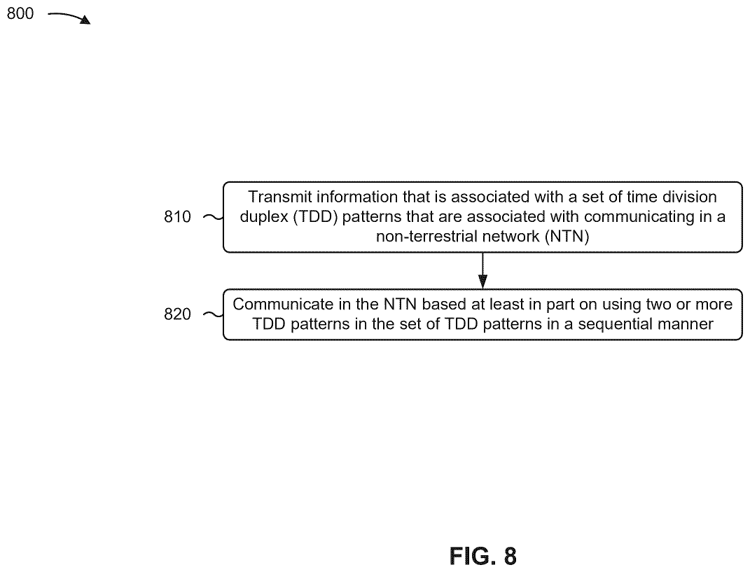

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with TDD in an NTN, as described in more detail elsewhere herein. For example, the processing system 145 of the network node 110, the processing system 140 of the UE 120, the CU 210, the DU 230, or the RU 240 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

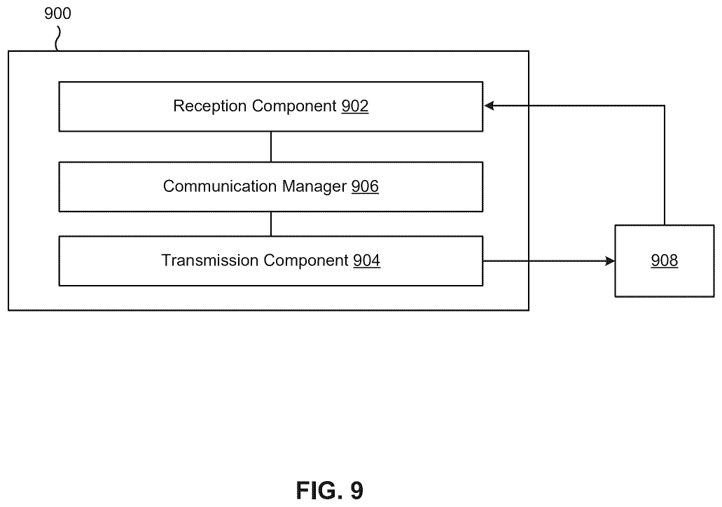

In some aspects, a UE (e.g., a UE 120) includes means for receiving information that is associated with a set of TDD patterns that are associated with communicating in an NTN; and/or means for communicating in the NTN based at least in part on using two or more TDD patterns in the set of TDD patterns in a sequential manner. The means for the UE to perform operations described herein may include, for example, one or more of communication manager 150, processing system 140, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

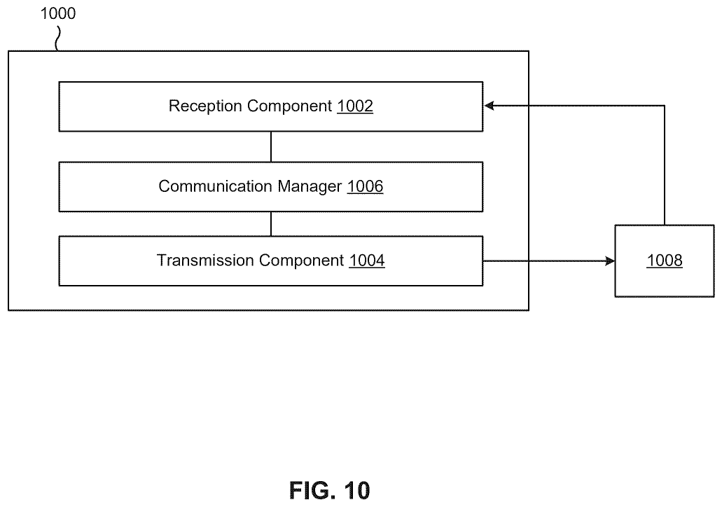

In some aspects, a network node (e.g., a network node 110) includes means for transmitting information that is associated with a set of TDD patterns that are associated with communicating in an NTN; and/or means for communicating in the NTN based at least in part on using two or more TDD patterns in the set of TDD patterns in a sequential manner. The means for the network node to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

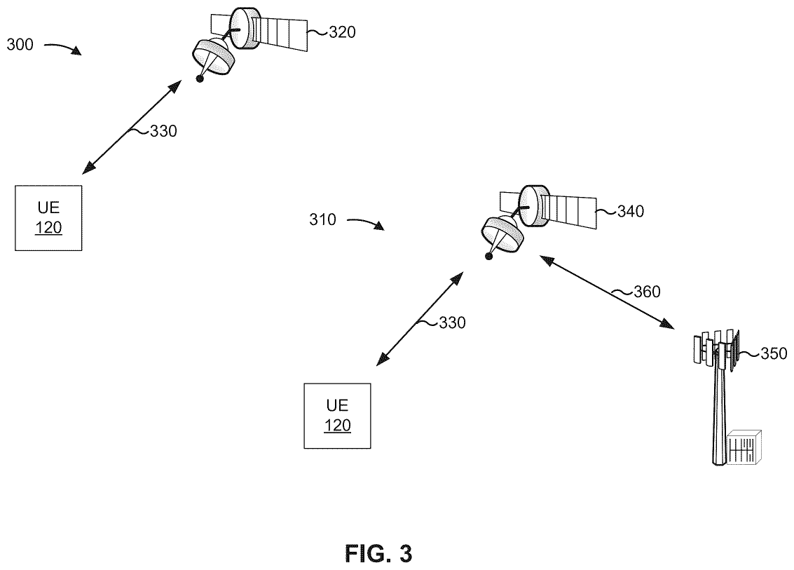

FIG. 3 is a diagram illustrating an example 300 of a regenerative satellite deployment and an example 310 of a transparent satellite deployment in a non-terrestrial network.

Example 300 shows a regenerative satellite deployment. In example 300, a UE 120 is served by a satellite 320 via a service link 330. For example, the satellite 320 may include a network node 110 (e.g., network node 110a) or a gNB. In some aspects, the satellite 320 may be referred to as a non-terrestrial base station, a regenerative repeater, or an on-board processing repeater. In some aspects, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite. The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360, and may amplify and/or filter the uplink radio frequency transmission. In some aspects, the UEs 120 shown in example 300 and example 310 may be associated with a GNSS capability or a Global Positioning System (GPS) capability, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120). An uplink of the service link 330 may be indicated by reference number 330-U (not shown in FIG. 3) and a downlink of the service link 330 may be indicated by reference number 330-D (not shown in FIG. 3). Similarly, an uplink of the feeder link 360 may be indicated by reference number 360-U (not shown in FIG. 3) and a downlink of the feeder link 360 may be indicated by reference number 360-D (not shown in FIG. 3).

The feeder link 360 and the service link 330 may each experience Doppler effects due to the movement of the satellites 320 and 340, and potentially movement of a UE 120. These Doppler effects may be significantly larger than in a terrestrial network. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

As indicated above, FIG. 3 is provided as an example. Other examples may differ from what is described with regard to FIG. 3.

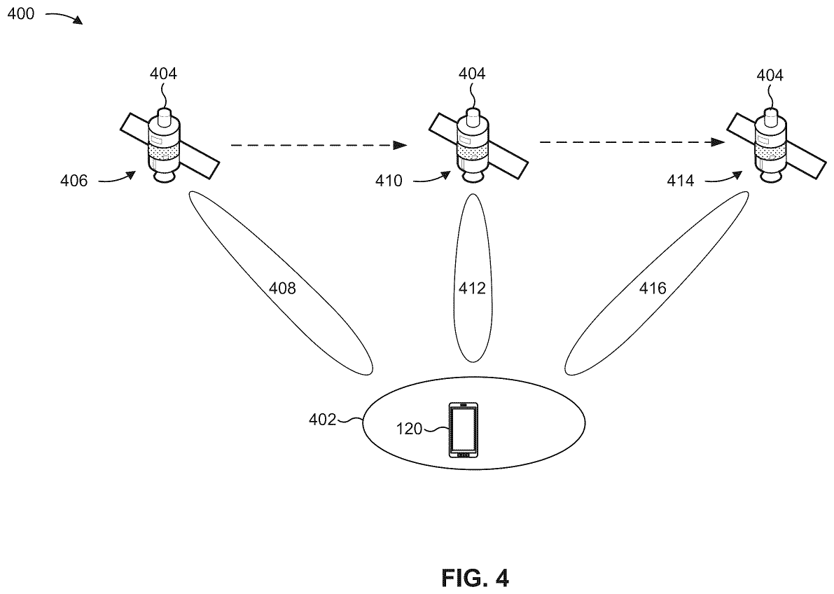

FIG. 4 is a diagram illustrating an example 400 of mobility in an NTN, in accordance with the present disclosure.

An NTN may provide wireless access and/or service coverage to UEs in areas in which terrestrial cellular service is unavailable and/or difficult to reach, such as a mountain top, a body of water, and/or a canyon. As one example of an NTN service coverage area, a UE 120 may operate in a coverage area 402 that is provided by a satellite 404. As described with regard to FIG. 3, the satellite 404 may communicate with the UE 120 as a transparent satellite that relays communications from a gateway or may include base station functionality and communicate with the UE 120 as a regenerative satellite.

As shown by FIG. 4, the satellite 404 may change locations, resulting in changes to how the satellite 404 provides the coverage area 402. To illustrate, the satellite 404 may operate at a first location as shown by reference number 406. At the first location, the satellite 404 may communicate with the UE 120 using a first beam 408 that is associated with a first elevation angle. The satellite may move to a second location as shown by reference number 410 and, based at least in part on moving to the second location, the satellite 404 may communicate with the UE 120 using a second beam 412 that is associated with a second elevation angle. In a similar manner, the satellite 404 may move to a third location as shown by reference number 414 and may communicate with the UE 120 using a third beam 416 that is associated with a third elevation angle. Alternatively, or additionally, the satellite 404 may provide the coverage area 402 to the UE 120 and/or other UEs based at least in part on the first beam 408, the second beam 412, and the third beam 416. In some examples, the beam 408, the beam 412, and the beam 416 may be transmitted from a same satellite antenna and/or using a same beam index, but pointed towards different directions with respect to the satellite 404.

Relative to communicating with a terrestrial network node, the UE 120 may experience and/or observe larger signal propagation delays and/or Doppler effects in wireless communications with the satellite 404. To illustrate, the satellite 404 may operate at a 600 kilometer (km) altitude and may provide communications at the 600 km altitude based at least in part on using a 25° MEA for beamformed communications. In such an operating scenario, the UE 120 may experience and/or observe different service link delay values in transmissions that are associated with the satellite 404. For example, the UE 120 may observe a first delay that is associated with the satellite 404 operating at the first location and communicating via the first beam 408, a second delay that is associated with the satellite 404 operating at the second location and communicating via the second beam 412, and a third delay value that is associated with the satellite 404 operating at the third location and communicating via the third beam. Example service link delays that may be observed by a UE include delays within a range between 2 milliseconds (msec) and 4 msec. Accordingly, the UE 120 may observe variations in a service link delay while communicating with a satellite as the satellite changes locations and/or uses a beam to communicate with the UE. In a scenario that includes a satellite that uses a quasi-earth fixed beam and/or provides a quasi-earth fixed cell, the satellite may steer the direction of a beam towards a fixed area and/or a UE. “Quasi-earth fixed beam” denotes a beam that maintains a specific coverage area relative to a surface of the Earth while the satellite moves, and “quasi-earth fixed cell” denotes a wireless coverage area that remains relatively stationary (e.g., within a movement threshold) and may be based at least in part on a moving satellite. In such a scenario, the UE 120 may observe variations in a service link delay while communicating with a satellite as the satellite changes locations and/or uses a considered beam to communicate with the UE. The satellite may steer and/or point the considered beam towards a fixed area along the satellite moment. “Considered beam” denotes a beam that satisfies an operating condition of having an associated radiation pattern directed to a targeted coverage area (e.g., a signal strength of the considered beam is maximized at the fixed area). Based at least in part on the coverage area having a large size (e.g., an area size that satisfies a large area threshold) and the coverage area being provided by a single satellite, the satellite may use different antenna beams at a considered time to cover different sub-areas of the coverage area, such that each sub-area is covered by the respective beam footprint.

Wireless communication devices operating in an NTN, such as a satellite and/or a UE 120, may use FDD to communicate with one another and/or may use FDD bands that are specified by an overseeing organization, such as band n254, band n255,band n256, band n510, band n511, and/or band n512 that are specified by 3GPP. To support FDD, a wireless communication device may include a duplexer that provides isolation between a transmitter and a receiver such that the wireless communication device may transmit and receive simultaneously (e.g., via different frequencies). Using the duplexer may provide simultaneous transmission and reception at the tradeoff of increased expense, increased size, and/or increased implementation complexity (e.g., thermal management, narrower filter designs, insertion loss management, and/or signal degradation management).

As an alternative to using FDD, wireless communication devices operating in an NTN may use time TDD to communicate with one another. In an example, NTN TDD communications may reuse TDD bands that are associated with a TN. To illustrate, a network operator in the United States may reuse TN bands (e.g., TDD TN bands) for satellite communications to provide complementary coverage to a TN network node. Example TN bands that may be reused for NTN communications may include TN TDD bands in FR1 (e.g., TDD bands that are located in between 3 GHz and 5 GHz) and/or FR2 bands that are allocated to TDD communications. The use of TDD for NTN communications may mitigate the increase in expense, size, and/or implementation complexity associated with the use of a duplexer based at least in part on the ability to perform TDD communications without a duplexer.

As indicated above, FIG. 4 is provided as an example. Other examples may differ from what is described with regard to FIG. 4.

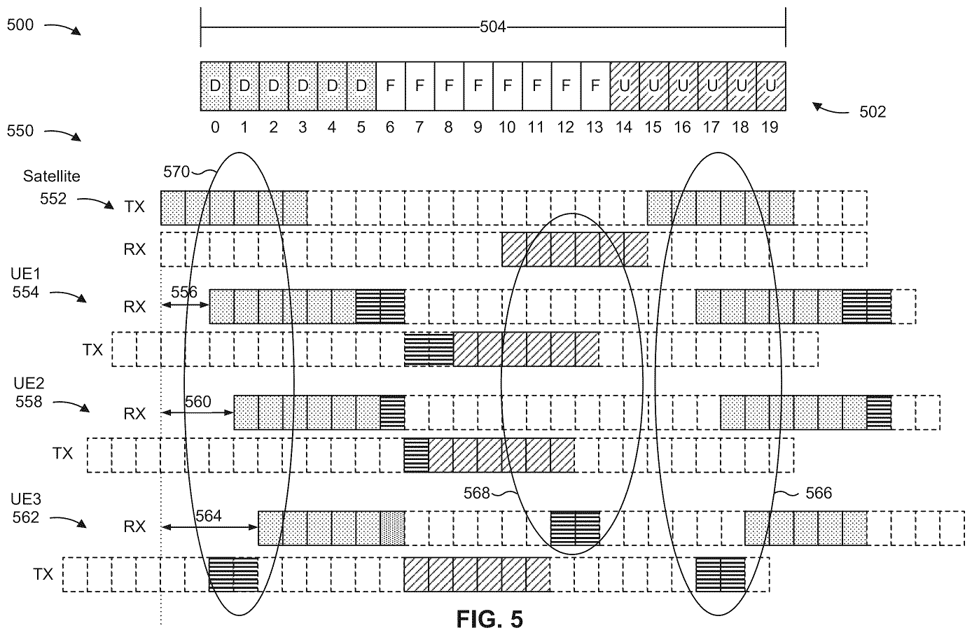

FIG. 5 is a diagram illustrating a first example 500 of a TDD pattern and a second example 550 of time delay variations, in accordance with the present disclosure.

The first example 500 includes a TDD pattern 502 that may be used by a satellite (e.g., a network node 110) to communicate with multiple UEs (e.g., multiple UEs 120). In some cases, the TDD pattern 502 may be referred to as a common TDD pattern, and “common TDD pattern” denotes a TDD pattern that is used satellite-wide, system-wide, and/or network-wide. For instance, a satellite may use a common TDD pattern (e.g., the TDD pattern 502) for respective downlink communications and/or respective uplink communications with each UE in a coverage area that is provided by the satellite. As shown by FIG. 5, the TDD pattern 502 may be based at least in part on sub-time partitions that are each given a respective communication assignment to a downlink communication, an uplink communication, and/or a flexible communication (e.g., a communication assignment that may be, a downlink communication, an uplink communication, or reserved).

To illustrate, the TDD pattern 502 spans a time partition 504 that has been divided into multiple sub-time partitions. As one example, the time partition 504 may be a mini-slot, a slot, a subframe, or a frame, and the sub-time partitions may be symbols, mini-slots, slots, or subframes, respectively. As shown by FIG. 5, the sub-time partitions of the time partition 504 are assigned to downlink communications, uplink communications, and/or flexible communications. For instance, sub-time partitions 0-5 of the time partition 504 are assigned to downlink communications (shown with a dotted pattern and marked with a “D”), sub-time partitions 6-13 are assigned to flexible communications (shown in solid white and marked with an “F”), and sub-time partitions 14-20 are assigned to uplink communications (shown with diagonal lines and marked with a “U”). While FIG. 5 shows specific communication assignments (e.g., downlink, flexible, and uplink) for specific sub-time partition ranges (e.g., sub-time partitions 0-5, 6-13, and 14-20), other examples may use communication assignments that are associated with different sub-time partition ranges and/or may use communication assignments in a different order than shown by FIG. 5.

In a TN, a UE and a network node may have a similar timing relationship such that a TDD pattern may be configured to avoid a downlink sub-time partition overlapping with an uplink sub-time partition at both the UE and the network node. To illustrate, in a TN, a propagation delay between the UE and the network node is small enough that the UE and the network node are nearly synchronized. Nearly synchronized may mean that the UE may apply a small timing advance value applied for an uplink transmission and/or there is a small difference for the timing of a considered symbol, a considered slot, and/or a considered subframe between at the UE and at the network node, where the small timing advance value and/or the small difference for the timing satisfies a small threshold. In an NTN system, the UE and/or the network node may observe larger propagation delays relative to propagation delays associated with TN communications based at least in part on the larger distance between a network node (e.g., a satellite) and the UE, and the larger propagation delays may result in the UE and the network node having different timing relationships that are less synchronized relative to TN communications. For instance, in an NTN uplink communication, the UE may transmit an uplink transmission based at least in part on applying, to the uplink transmission, a timing advance (TA) that compensates for a round trip time (RTT) between the UE and an UL synchronization reference point (SRP). An example UL SRP may be a point along a feeder link between a satellite and an on-ground network node. The UL SRP may be selected by a terrestrial network node, a non-terrestrial network node (e.g., a regenerative satellite), and/or a ground station. However, different UEs may compute, and use, different TAs such that their UL signals would arrive at the UL SRP with a good time alignment (e.g., a time alignment that ensures orthogonality).

The second example 550 includes a satellite communicating with multiple UEs using the TDD pattern 502 as a common TDD pattern. As shown by reference number 552, communications by the satellite that are based at least in part on the TDD pattern 502 have been split into an upper portion that emphasizes downlink transmissions (shown with a dotted pattern) by the satellite and a lower portion that emphasizes uplink receptions (shown with a diagonal pattern) by the satellite based at least in part on the TDD pattern 502 communication assignments. Flexible sub-time partitions and reciprocal sub-time partitions (e.g., downlink sub-time partitions in the upper portion associated with transmissions by the satellite and uplink sub-time partitions in the lower portion that is associated with reception by the satellite) are shown in solid white with and a dashed line. To communicate with multiple UEs, the satellite may transmit and/or receive downlink transmissions and uplink transmissions as indicated by the TDD pattern 502 and using a respective beam for each UE, such as by using a first beam with a 25° angle to communicate with a first UE, using a second beam with a 60° angle to communicate with a second UE, and/or using a third beam with a 90° angle to communicate with a third UE. The variations in the angles of the beams may be based at least in part on each UE operating at a respective location, and each beam and/or UE location may be associated with a different propagation delay, latency, and/or RTT from one another. For instance, each UE may compute a respective RTT using a same UL SRP that results in varying RTTs due to the varying UE locations and/or varying satellite positions. Accordingly, a first UE (shown as UE1) may transmit and/or receive communications with the satellite as shown by reference number 554 and based at least in part on a first propagation delay 556. In a similar manner as the satellite, communications by the first UE that are based at least in part on the TDD pattern 502 have been split into an upper portion that emphasizes downlink reception (shown with a dotted pattern) by the first UE and a lower portion that emphasizes uplink transmission (shown with a diagonal pattern) by the first UE based at least in part on the TDD pattern 502 communication assignments. In some aspects, the first UE may be configured to use at least some flexible sub-time partitions for reception (shown with horizontal lines) and/or some flexible sub-time partitions for transmission (also shown with horizontal lines). Unused flexible sub-time partitions and reciprocal sub-time partitions are shown in solid white with and a dashed line.

In a similar manner as the first UE, as shown by reference number 558, a second UE (shown as UE2) may transmit and/or receive communications with the satellite based at least in part on a second propagation delay 560. Alternatively, or additionally, as shown by reference number 562, a third UE (shown as UE3) may transmit and/or receive communications with the satellite as based at least in part on a third propagation delay 564. Communications by the second UE and the third UE that are based at least in part on the TDD pattern 502 have been split into respective upper portions and respective lower portions in a similar manner as described with regard to the first UE. Flexible sub-time partitions that have been configured for transmission and/or reception by the respective UE are shown with horizontal lines, and unused flexible sub-time partitions and reciprocal sub-time partitions are shown in solid with a dashed line. In some aspects, a network node may determine a TDD pattern for one or multiple UEs by considering the propagation delay, such that the TDD patterns do not cause an uplink transmission from the UE to overlap with an downlink reception at the same UE and/or the TDD patterns resolve a half duplex constraint at the UE. That is, the propagation delay for one or multiple UEs may change due to the relative movement between the UE and the satellite such that using the same TDD pattern as before may not be preferred based at least in part on the TDD pattern potentially having an overlapping between the uplink and downlink (e.g. at the one or multiple UEs). Based at least in part on the propagation delay change, a network node may determine and configure a new TDD pattern for communicating with the one or multiple UEs. That is, the network node may determine and configure the new TDD pattern based at least in part on considering the new propagation delay.

Each UE may compute a latency that is associated with a respective propagation delay, such as by computing an RTT using an UL SRP that is indicated by a network node. In some cases, the first UE, the second UE, and the third UE may use a same UL SRP to compute the respective latency and/or RTT. The variations in delays between the different UEs may result in a downlink communication by the satellite at least partially overlapping with an uplink communication by one or more UEs, as shown by reference number 566 (e.g., an overlap between a first transmission by the third UE and a second transmission by the satellite), reference number 568 (e.g., an overlap in reception by the third UE and transmissions by the first UE and the second UE), and reference number 570 (e.g., an overlap in a transmission by the third UE and reception by the first UE and the second UE). Alternatively, or additionally, based at least in part on the movement of a satellite as described with regard to FIG. 3, a UE may observe and/or compute different latencies and/or RTTs at different points in time for a communication link with the satellite. For example, at a first instance in time while communicating with the satellite, the first UE may compute a first latency that is associated with the first propagation delay 556 and, at a second instance in time while communicating with the satellite, the first UE may observe and/or compute a second latency that is associated with the third propagation delay 564 in a similar manner as experienced by the third UE based at least in part on movement by the satellite relative to the first UE.

To mitigate overlaps (e.g. at a UE or a network node) between downlink communications and uplink communications in an NTN, a network node (e.g., a satellite, a ground station, and/or a terrestrial network node) may determine to change a TDD pattern that is used to communicate with a UE. For instance, a satellite may determine to change from using a first TDD pattern to communicate with a UE to using a second TDD pattern to communicate with the UE based at least in part on an RTT changing (e.g., by a difference threshold). In some cases, the UE may compute and transmit an indication of an RTT to the network node. Alternatively, or additionally, a network node may compute the RTT of one or multiple UEs (e.g. based at least in part on the location of the one or multiple UEs and/or one or more beam parameters such as beam footprint). In some cases, the satellite may receive an instruction (e.g., from a ground station) to change TDD patterns. Changing from using a first TDD pattern to using a second TDD pattern may include reducing and/or increasing a quantity of sub-time partitions (e.g., symbols) that are assigned to downlink communications, reducing and/or increasing a quantity of sub-time partitions that are assigned to uplink communications, and/or changing a communication assignment of a time partition (e.g., symbol in the flexible sub-time partition) to mitigate overlaps between uplink communications and downlink communications.

A network node may broadcast an indication of a TDD pattern in a SIB, such as a SIB1. To indicate a change in the TDD pattern (e.g., from a first TDD pattern to a second TDD pattern), the network node may trigger a UE to perform a system information (SI) update procedure. As at least part of performing the SI update procedure, the UE may receive and/or decode the SIB to derive a new TDD pattern to use for communications with the network node. Using an SI update procedure to trigger the UE to update a TDD pattern may result in ambiguities, resource waste, and/or increased power consumption at a UE. For instance, the network node that triggers the SI update procedure may not receive confirmation from the UE that indicates the UE has successfully received the SIB and/or has successfully applied the updated TDD pattern. Accordingly, the network node may refrain from assigning resources to the UE during a SIB modification period, potentially resulting in air interface resources being unused and/or wasted. As another example, triggering an SI update procedure for each update to a TDD pattern may increase how often the UE receives and decodes the SIB to obtain updated TDD pattern information, resulting in increased power consumption at the UE and/or increased signaling overhead in the NTN that results in fewer resources being available for data traffic. Resource waste and the increased signaling overhead may lead to increased data transfer latencies and reduced data throughput in a wireless network. Alternatively, or additionally, increased power consumption at a UE may reduce an operating duration of the UE.

Various aspects relate generally to TDD in an NTN. Some aspects more specifically relate to a network node and/or a UE using a set of TDD patterns in a sequential manner. In some aspects, a UE may receive information that is associated with a set of TDD patterns that are associated with communicating in an NTN. As one example, the UE may receive an indication of a set of TDD patterns in a SIB. As another example, the UE may receive an indication of multiple RRC configured TDD patterns in Layer 3 signaling, and selection of one or more particular TDD patterns (e.g., from the multiple RRC configured TDD patterns) in Layer 1 signaling and/or Layer 2 signaling. Based at least in part on receiving the information, the UE may communicate in the NTN based at least in part on using two or more TDD patterns in the set of TDD patterns in a sequential manner.

In some aspects, a network node may transmit information that is associated with a set of TDD patterns that are associated with communicating in an NTN. For instance, the network node may be a satellite that provides wireless access to a network, and the satellite may transmit an indication of the set of TDD patterns in a SIB as described below. Based at least in part on transmitting the information, the network node may communicate in the NTN based at least in part on using two or more TDD patterns in the set of TDD patterns in a sequential manner.

Particular aspects of the subject matter described in this disclosure can be implemented to realize one or more of the following potential advantages. In some examples, by indicating information that may be used to obtain and/or derive a set of TDD patterns, the described techniques can be used to enable a network node and a UE to communicate in an NTN in a manner that mitigates resource waste, increased overhead signaling, and/or increased power consumption at a UE. For instance, the network node may indicate the set of TDD patterns in a single SIB to reduce signaling overhead, and the network node and/or the UE may sequentially apply two or more of the TDD patterns in the set in a coordinated manner (e.g., without additional signaling overhead). In some aspects, each TDD pattern in the set of TDD patterns may be associated with a respective application time such that the network node may assume when the UE will switch a TDD pattern, thus enabling the network node to allocate air interface resources that might otherwise not been used, and reduce resource waste. In some aspects, the network node and the UE may switch the applied TDD pattern used to communicate with one another in a coordinated and simultaneous manner (e.g., without additional signaling overhead).

The use of a set of TDD patterns may also reduce how often the network node triggers an SI update procedure at the UE, thus reducing how often the UE receives and decodes the SIB to obtain updated TDD pattern information, and decrease power consumption at the UE. Reducing resource waste and signaling overhead may lead to decreased data transfer latencies and increased data throughput in a wireless network. Alternatively, or additionally, decreasing power consumption at a UE may extend an operating duration of the UE.

As indicated above, FIG. 5 is provided as an example. Other examples may differ from what is described with regard to FIG. 5.

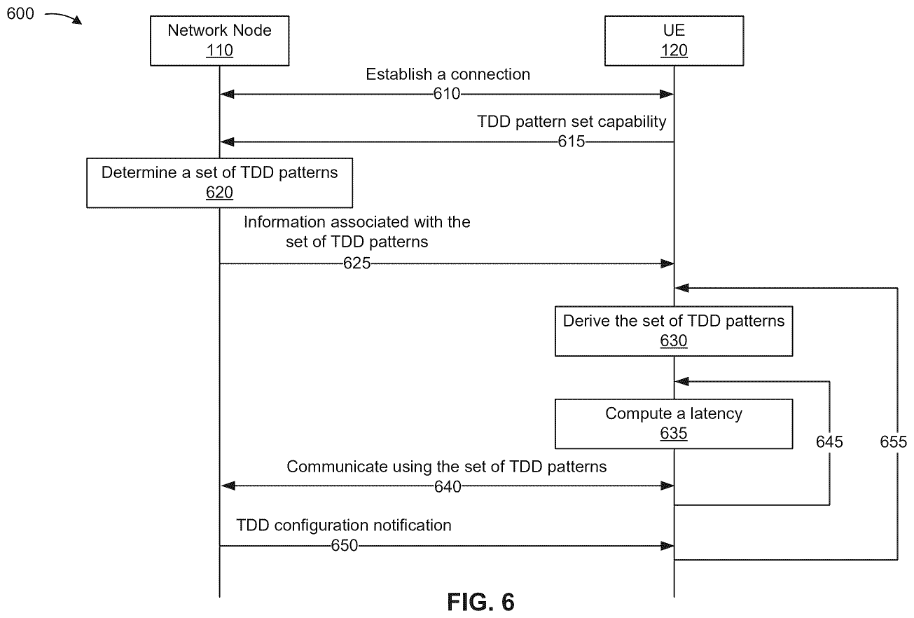

FIG. 6 is a diagram illustrating an example 600 of a wireless communication process between a network node (e.g., the network node 110) and a UE (e.g., the UE 120), in accordance with the present disclosure. In some aspects, the network node 110 may be associated with an NTN, such as a network node that is implemented as a satellite, and the wireless communication process may be associated with communications in the NTN.

As shown by reference number 610, which is an optional step, a network node 110 and a UE 120 may optionally establish a connection. To illustrate, the UE 120 may power up in a cell coverage area provided by the network node 110, and the UE 120 and the network node 110 may or may not perform one or more procedures (e.g., a random access channel (RACH) procedure and/or an RRC procedure) to establish a wireless connection. In some cases, the UE 120 may perform procedures to receive the MIB and/or SIB without entering the RRC_CONNECTED state. As another example, the UE 120 may move into the cell coverage area provided by the network node 110 and may perform a handover from a source network node (e.g., another network node 110) to the network node 110. Alternatively, or additionally, the network node 110 and the UE 120 may communicate via the connection based at least in part on any combination of Layer 1 signaling (e.g., DCI and/or UCI), Layer 2 signaling (e.g., a MAC CE), and/or Layer 3 signaling (e.g., RRC signaling). To illustrate, the network node 110 may request, via RRC signaling, UE capability information, and/or the UE 120 may transmit, via RRC signaling, the UE capability information. As part of communicating via the connection, the network node 110 may transmit configuration information via Layer 3 signaling (e.g., RRC signaling), and activate and/or deactivate a particular configuration via Layer 2 signaling (e.g., a MAC CE) and/or Layer 1 signaling (e.g., DCI). To illustrate, the network node 110 may transmit the configuration information via Layer 3 signaling at a first point in time associated with the UE 120 being tolerant of communication delays, and the network node 110 may transmit an activation of the configuration via Layer 2 signaling and/or Layer 1 signaling at a second point in time associated with the UE being less tolerant to communication delays.

While the example 600 includes the network node 110 establishing a connection with the UE 120, other examples may not include the network node 110 establishing the connection with the UE 120 as described above. Accordingly, the actions description with regard to reference number 610 may be optional.

As shown by reference number 615, which is an optional step, the UE 120 may optionally transmit, and the network node 110 may optionally receive, an indication of a TDD pattern set capability. As one example, the UE 120 may indicate support for receiving and/or using a set of TDD patterns. For clarity, FIG. 6 illustrates the UE 120 transmitting the indication of the TDD pattern set capability in a separate transaction than establishing a connection with the network node 110. However, in some aspects, the UE 120 may transmit the indication of the TDD pattern set capability as part of establishing a connection with the network node 110. As described above, in some examples, the UE 120 may not establish a connection with the network node 110 and, consequently, may not transmit an indication of a TDD pattern set capability to the network node 110.

As shown by reference number 620, the network node 110 may determine a set of TDD patterns. As an example, the network node 110 may use orbital parameters, ephemeris data, and/or a satellite propagation model to compute multiple latencies, multiple propagation delays, and/or multiple RTTs that are associated with communicating with a UE in a coverage area that is provided by the network node 110. For instance, the network node 110 may use the orbital parameters, the ephemeris data, and/or the satellite propagation model to predict and/or calculate one or more network node locations (e.g., multiple satellite positions) over time. In some aspects, the network node 110 may use the predicted and/or calculated network node locations to compute multiple latencies, the multiple propagation delays, and/or the multiple RTTs using a respective NTN communication beam (e.g., a service link beam) associated with each predicted network node location. For example, the network node 110 may compute and/or predict multiple beam configurations (e.g., multiple service link beams, changes to a service link beam, and/or a rate of change to a service link beam) to use for maintaining a service link with the UE 120 over time at the different predicted and/or calculated network node locations. The network node 110 may compute a respective propagation delay, latency, and/or RTT that is associated with each beam configuration, and use the multiple latencies, the multiple propagation delays, and/or multiple RTTs to determine a set of TDD patterns that mitigate transmission and reception overlaps, such as the transmission and reception overlaps described with regard to FIG. 5.

While the example 600 includes the network node 110 communicating with a single UE 120, other examples may include the network node 110 communicating with multiple UEs (e.g., multiple UEs 120), and each UE may be positioned at a different location within a coverage area provided by the network node 110. In some cases, the multiple UEs may be served by the same satellite beam and/or the same satellite cell, such as in a scenario in which the multiple UEs are located within the footprint area of the same satellite beam and/or satellite cell). Accordingly, each UE may compute and/or observe slightly different RTT values for a same beam transmitted by the network node 110 (e.g., differences that are within a small difference threshold). In some aspects, the network node 110 may select one or more TDD patterns that are based at least in part on a service link beam that may be used by multiple UEs in different locations, such as a beam with a beamwidth that satisfies a wide beam threshold. That is, the network node 110 may select the TDD pattern(s) to mitigate transmission and reception overlaps based at least in part on the RTT differences that are within the small difference threshold, such as by reassigning a flexible sub-time partition to a communication type that mitigates the overlap.

As shown by reference number 625, the network node 110 may transmit, and the UE 120 may receive, information that is associated with a set of TDD patterns. For clarity, FIG. 6 illustrates the network node 110 transmitting the information in one signaling transaction (e.g., a Layer 1 transmission, a Layer 2 transmission, or a Layer 3 transmission), but some examples may include the network node 110 transmitting the information in multiple signaling transactions (e.g., a combination of one or more Layer 1 transmissions, one or more Layer 2 transmissions, and/or one or more Layer 3 transmissions).

In one example, the network node 110 may transmit, as the information, the set of TDD patterns and/or selection of a particular TDD pattern. To illustrate, a communication standard may specify multiple TDD patterns and each TDD pattern may be associated with a respective TDD pattern identifier (ID). The network node 110 may indicate multiple TDD pattern IDs that are included in the set of TDD patterns. As another example, the network node 110 may indicate, for each TDD pattern in the set of TDD patterns, any combination of a time duration (e.g., a slot or mini-slot) of a TDD pattern, a quantity of sub-time partitions (e.g., a quantity of symbols) in the TDD pattern, and/or a respective communication assignment (e.g., a downlink assignment, an uplink assignment, and/or a flexible assignment) for each sub-time partition in the TDD pattern. As yet another example, the network node 110 may transmit a table of TDD patterns in a first signaling transaction (e.g., Layer 3 signaling and/or a SIB), where the table indicates multiple sets of sub-time partitions and the associated communication assignments for each sub-time partition. Each set of sub-time partitions in the table may be a TDD pattern, and, at a later point in time, the network node 110 may indicate selection of one or more TDD patterns in a second signaling transaction (e.g., Layer 1, Layer 2, or Layer 3 signaling), such as by indicating a respective table index for each selected TDD pattern.

Each TDD pattern may be associated with respective time information that indicates an application time for the associated TDD pattern (e.g., when to use and/or apply the associated TDD pattern). In some aspects, the information transmitted by the network node 110 may include and/or indicate the respective time information for each TDD pattern in a set of TDD patterns. The time information may be indicated using GNSS timing and/or using universal coordinated time (UTC) timing. In some aspects, the time information may be based at least in part on an NTN time partition, such as a frame time partition, a sub-frame time partition, and/or a slot time partition. Alternatively, or additionally, the time information may be based at least in part on a time offset, as described below.

The network node 110 may transmit the information that is associated with the set of TDD patterns using a delta configuration and/or a difference configuration. For instance, the information may indicate a first absolute TDD pattern that explicitly specifies a respective communication assignment for each sub-time partition in the absolute TDD pattern. For subsequent TDD patterns in the set of TDD patterns, the information may indicate differences from the absolute TDD pattern (e.g., a delta TDD pattern). As one example, a delta TDD pattern may indicate a change to a third sub-time partition communication assignment that is relative to the absolute TDD pattern and may omit sub-time partition communication assignments for sub-time partitions that have a same communication assignment as the absolute TDD pattern. However, other delta TDD patterns may indicate more than one sub-time partition communication assignment difference. Using a delta configuration and/or a difference configuration to indicate a set of TDD patterns may reduce a signaling overhead and preserve air interface resources for other transmissions, resulting in increased data throughput and/or reduced data transfer latencies in the NTN. The UE 120 may subsequently derive the set of TDD patterns using the absolute TDD pattern and the delta TDD patterns.

While the information transmitted by the network node 110 may include and/or indicate the set of TDD patterns, in some examples the information may indicate a configuration, a function, and/or a rule that may be used by the UE 120 to select and/or derive one or more TDD patterns. For instance, the network node 110 may indicate a configuration and/or a rule that indicates to change a TDD pattern based at least in part on a propagation delay, a latency, and/or an RTT changing by a threshold value. Alternatively, or additionally, the network node 110 may indicate the change to apply to the TDD pattern, such as indicating a first change that is associated with switching a communication assignment of a first one or more sub-time partitions from flexible to uplink communications and/or a second change that is associated with switching a communication assignment of a second one or more sub-time partitions from flexible to downlink communications. The information transmitted by the network node 110 may indicate the communication assignment change and/or the sub-time partitions. In some aspects, the communication assignment change may be based on RRC configured information that indicates multiple potential communication assignment changes and/or IDs associated with the potential communication assignment changes. In other aspects, the information may indicate the communication assignment change using a bitmap that maps to one or more sub-time partitions (e.g., flexible sub-time partitions) and setting each bit to a value that maps to a respective communication assignment.

The network node 110 may transmit the information that is associated with the set of TDD patterns in a SIB, such as a SIB1 and/or another SIB type. To illustrate, the SIB and/or the SIB1 may indicate a current TDD pattern and/or a current TDD configuration to use, and a future TDD pattern and/or a future TDD configuration. In some aspects, the SIB may indicate selection of two or more TDD patterns that are specified by a communication standard, such as by indicating two or more TDD pattern IDs. In other aspects, the SIB may indicate a current TDD pattern as an absolute TDD pattern and one or more delta TDD patterns for future use (e.g., future TDD patterns). The network node 110 may transmit multiple SIBs to indicate the current TDD pattern and one or more future TDD patterns, such as by indicating a current TDD pattern in a SIB1 and one or more future TDD patterns (e.g., delta TDD patterns or additional absolute TDD patterns) in a second SIB that is different from the SIB1. Using a second SIB to indicate the future TDD patterns may reduce a size of the SIB1, which may result in reducing an access latency.

In some aspects, the network node 110 may indicate multiple potential TDD patterns and/or multiple potential rules (e.g., for deriving a TDD pattern). That is, the network node 110 may preconfigure multiple potential TDD patterns and/or multiple potential rules, such as in a SIB transmission. At a later point in time, the network node 110 may transmit, as the information, an indication of a selection of a particular TDD pattern from the multiple potential TDD patterns and/or a particular rule from the multiple potential rules, such as in DCI. In transmitting the indication of the selection of a particular TDD pattern and/or the particular rule, the network node 110 may implicitly instruct the UE 120 to switch to the particular TDD pattern and/or to derive a new TDD pattern (e.g., based at least in part on the particular rule). By preconfiguring multiple potential TDD patterns and/or multiple potential rules, the network node 110 may select a TDD pattern and/or a rule based at least in part on current conditions that may lead to more synchronized communications relative to predicted TDD patterns and, consequently, mitigate overlapped transmission and reception more effectively. Alternatively, or additionally, the network node 110 may skip and/or not perform the computations used to generate the predicted network node locations, beam configurations, multiple latencies, multiple propagation delays, and/or the multiple RTTs as described above, and preserve computational resources for other tasks.

As described above, the information transmitted by the network node 110 may indicate and/or include time information that indicates a respective application time and/or a respective usage time for a respective TDD pattern in the set of TDD patterns. In some aspects, the time information may be based at least in part on a time offset and/or an NTN time partition, such as a time offset that is relative to a system frame number (SFN), a subframe, and/or a quantity of SFN wrap-arounds (e.g., resets to zero) that is associated with the NTN. To illustrate, the network node 110 may indicate a TDD pattern time offset that is relative to a start of a system information (SI) window, which may be configured by NW and/or calculated at the UE based on a configured function or rule, and the UE 120 may use the TDD pattern time offset to compute an application time and/or activation time of an associated TDD pattern, such as by adding the TDD pattern time offset to the start of the SI window and/or an SI modification period associated with receiving a SIB.

As shown by reference number 630, the UE 120 may derive the set of TDD patterns using the information. For instance, based at least in part on the information indicating a configuration, a function, and/or a rule, the UE 120 may derive one or more TDD patterns. Alternatively, or additionally, the information may indicate a communication assignment change that is used by the UE 120 to derive one or more TDD patterns. In some aspects, the information may indicate and/or include an absolute TDD pattern and one or more delta TDD patterns, and the UE 120 may derive one or more TDD patterns using the delta TDD pattern(s) and an absolute TDD pattern.

While the example 600 includes the UE 120 deriving the set of TDD patterns, in other examples the UE 120 may not derive a set of TDD patterns. For example, the information transmitted by the network node 110 may indicate and/or include the set of TDD patterns.

As shown by reference number 635, the UE 120 may compute a latency that is associated with communicating with the network node 110. As one example, the UE 120 may compute a latency that is based at least in part on a distance and/or a latency between an UL SRP and a reference point that is indicated by a network node (e.g., the network node 110). One example of a reference point is a center of the service link beam footprint on the ground. Alternatively, or additionally, the UE 120 may compute an RTT using the UL SRP and the reference point.

Based at least in part on computing the latency, the UE 120 may identify and/or derive a particular TDD pattern, from the set of TDD patterns, that is associated with the latency. For instance, the information indicated by the network node 110 may associate each TDD pattern with a respective latency. In some aspects, the UE 120 may use a rule and/or configuration indicated by the network node 110 as described with regard to reference number 625 to select and/or derive the particular TDD pattern. Alternatively, or additionally, the network node 110 may compute a latency in the same manner as the UE 120 and/or select and/or derive the particular TDD pattern from the set of TDD patterns using the latency such that the network node 110 and the UE 120 are synchronized in selecting, switching, and/or applying the particular TDD pattern.

As described above, the network node 110 may service multiple UEs using a same service link beam, and each UE may compute different latency values and/or RTT values based at least in part on each UE potentially using different algorithms and/or computations to compute the latency and/or RTT. In some aspects, the UE 120 may receive an indication of a time offset and/or an instruction to use the time offset based at least in part on the latency and/or RTT satisfying a threshold, such as in the information transmitted by the network node 110, as at least part of a rule and/or configuration, and/or in separate signaling relative to the information. Based at least in part on the latency satisfying the threshold, the UE 120 may apply the TDD pattern at a time instance that the UE 120 computes using the time offset. The use of a time offset to modify when the UE 120 applies and/or uses a particular TDD offset may mitigate misalignments to different UEs that are serviced by a same service link beam and, consequently, mitigate overlaps in transmission and reception.

As shown by reference number 640, the network node 110 and the UE 120 may communicate using the set of TDD patterns. In some aspects, the network node 110 and/or the UE 120 may communicate based at least in part on applying two or more TDD patterns in the set of TDD patterns in a sequential manner. For instance, the UE 120 may compute a first latency as described with regard to reference number 635 and may select a first TDD pattern from the set of TDD patterns. The first TDD pattern may be associated with the first latency, such as by having an associated latency that is indicated by the network node 110 in time information that is within a threshold of the first latency and/or may be derived by the UE 120 using the first latency and based at least in part on a configuration and/or rule. In some aspects, as shown by reference number 645, the UE 120 may iteratively compute a latency and sequentially switch from using the first TDD pattern to using a second TDD pattern. To illustrate, based at least in part on a second latency satisfying a threshold, the UE 120 may switch from using the first TDD pattern to using the second TDD pattern, where the second TDD pattern may be associated with the second latency.

The UE 120 and/or the network node 110 may sequentially switch between using TDD patterns without further overhead signaling that indicates a switch to another TDD pattern. For instance, as described above, when the information transmitted by the network node includes respective timing information that is associated with applying a respective TDD pattern within the set of TDD patterns, the UE 120 and the network node 110 may autonomously and simultaneously switch from using a first TDD pattern to using a second TDD pattern without ambiguity and without additional signaling overhead. That is, the UE 120 may switch to the second TDD pattern without receiving a message that indicates to switch to the second TDD pattern. The ability to switch autonomously and simultaneously may also mitigate interruptions to the communications between the network node 110 and the UE 120 and, consequently, mitigate increases to data transfer latencies. Alternatively, or additionally, the network node 110 and/or the UE 120 may autonomously and simultaneously switch between TDD patterns without the network node 110 triggering an SI update at the UE 120. Accordingly, autonomously switching to a TDD pattern without an SI update may reduce power consumption at the UE 120 and/or may extend an operating duration of the UE 120.

In other examples, the network node 110 may trigger a switch to the second TDD pattern using Layer 1 signaling and/or Layer 2 signaling. For instance, as described above, the network node 110 may transmit a table of potential TDD patterns in Layer 3 signaling (e.g., RRC signaling) or one or multiple SIB(s) at a first point in time, and may signal a TDD pattern switch command and/or selection of a particular TDD pattern in the table in DCI at a second point in time. The TDD pattern switch command may explicitly indicate to switch TDD patterns, and selection of the particular TDD pattern may implicitly indicate to switch TDD patterns. The ability to signal a TDD pattern switch may enable the network node 110 to select TDD patterns based at least in part on current operating conditions.

As shown by reference number 650, the network node 110 may transmit, and the UE 120 may receive, a TDD configuration notification. One example of a TDD configuration notification may include the network node adding a new TDD pattern to the set of TDD patterns, such as by appending the new TDD pattern to an end (e.g., sequential end and/or a time-based end) to the set of TDD patterns. As another example, the network node 110 may change an absolute TDD pattern that is used to derive other TDD patterns. As a third example, a TDD configuration notification may indicate a change to a TDD pattern that follows a current set of TDD patterns (e.g., the change to the TDD pattern is based at least in part on a TDD pattern included in the current set of TDD patterns) and, as a fourth example, a TDD configuration notification may indicate that a change to a TDD pattern does not follow the current set of TDD patterns (e.g., the change to the TDD pattern is not associated with a TDD pattern included in the current set of TDD patterns). In some aspects, the network node 110 may transmit the TDD configuration notification in a SIB.

The transmission of a TDD configuration notification may, or may not, trigger an SI update at the UE 120. For instance, based at least in part on a time duration associated with applying a current TDD pattern expiring, the network node 110 may switch to a next TDD pattern in the set of TDD patterns and/or may set the next TDD pattern to a (new) current TDD pattern. Switching to the next TDD pattern as the current TDD pattern may not necessitate triggering an SI update procedure at the UE 120. As another example, the network node 110 may add a new TDD pattern (e.g., to the set of TDD patterns) for a time duration that occurs after an application time of a last TDD pattern in the set of TDD patterns, which may also not necessitate triggering an SI update procedure at the UE 120. To indicate that an SI update procedure does not need to be performed, the network node 110 may set a tag value associated with a SIB that indicates the TDD configuration notification to a same value as a tag value that is associated with the set of TDD patterns. For instance, the network node may transmit the information associated with the set of TDD patterns via a first SIB, and the first SIB may be associated with a tag value. The network node 110 may transmit the TDD configuration notification in a second SIB and, to indicate that there is no change to the application of the set of TDD patterns and/or to indicate to not perform a SI update procedure, the network node 110 may set a tag value of the second SIB to a same value that was used for the first SIB. In another example, the network node 110 may not need to send a paging message indicating system information change associated to the TDD configuration.

Based at least in part on the TDD configuration notification indicating that a TDD pattern change does not follow the current set of TDD patterns, the network node 110 may trigger an SI update procedure at the UE 120. For instance, the network node 110 may set a tag value of the second SIB carrying the TDD configuration notification to a different value than a tag value of the first SIB that indicated the information associated with the current set of TDD patterns. In another example, the network node 110 may send a paging message indicating system information change, such that a UE may be triggered to read the SIB. Based at least in part on the second SIB having a different tag value relative to the first SIB, the UE 120 may complete reception and/or decoding of the SIB and perform an SI update. For instance, a first set of TDD patterns may be associated with an expiration time, and the network node 110 may signal (e.g., via the TDD configuration notification) to switch from using the first set of TDD patterns to using a second set of TDD patterns based at least in part on the first set of TDD patterns expiring.

As shown by reference number 655, and based at least in part on receiving an indication to perform an SI update procedure, the UE may derive an updated set of TDD patterns in a similar manner as described with regard to reference number 630 (e.g., using updated information that is indicated by the TDD configuration indication), may compute a latency as described with regard to reference number 635, and/or may communicate with the network node 110 based at least in part on the updated information and/or the updated set of TDD patterns. The UE 120 and/or network node 110 may switch from using a first set of TDD patterns to using a second set of TDD patterns, where the second set of TDD patterns may be derived using information indicated in the TDD configuration notification. The ability to update a set of TDD patterns provides the network node 110 with the flexibility to change a TDD pattern based at least in part on current conditions observed by the network node 110 (e.g., a current load, number of UEs serviced by the network node, and/or a change in the data traffic pattern/characters associated to the serviced UEs).

While the network node 110 may trigger an SI update procedure at the UE 120 that causes the UE to complete reception and/or the decoding of a SIB, the UE 120 may alternatively or additionally determine to receive and/or decode a SIB in an autonomous manner. For instance, prior to expiration of an active time duration of a last TDD pattern in a current set of TDD patterns (e.g., a time duration during which the last TDD pattern is valid), the UE 120 may determine to receive and/or decode a SIB to derive an updated set of TDD patterns. The UE 120 autonomously determining to receive updated TDD configuration information (e.g., via a SIB) may enable the UE 120 to obtain information that enables future communications with the network node 110 in a seamless manner.

In some aspects, the UE 120 may be configured (e.g., via a higher protocol layer relative to a protocol layer that performs TDD management) for a transmission or a reception via an uplink grant or a downlink grant, respectively, such as through any combination of a configured grant, semi-persistent scheduling, RACH, CSI-RS, a positioning reference signal (PRS), PUCCH, and/or PDCCH. The UE 120 may determine that the transmission and/or reception is incompatible and/or collides with a current TDD configuration (e.g., derived from a TDD configuration notification). In such a scenario, the UE 120 may skip performing the transmission and/or reception in air interface resources associated with the collision and/or the incompatibility. Alternatively, or additionally, the UE 120 may deactivate the transmission and/or reception, such as by deactivating the configured grant and/or the semi-persistent scheduling.

The UE 120 may be configured with an uplink and/or downlink configuration (e.g., a TDD configuration and/or a TDD pattern) via a unicast message, such as unicast RRC signaling. For example, the UE 120 may receive a unicast message that indicates symbol resource configuration information, where a symbol resource configuration may indicate a TDD pattern. To illustrate, a symbol resource configuration may indicate a set of communication assignments for a set of symbols in a similar manner as a TDD pattern, and the symbol resource configuration information may include one or more symbol resource configurations. In some aspects, the symbol resource configuration information received from the unicast message may not align with the configuration included in a set of TDD patterns received from SIB(s) at least partially. In such a scenario, when the UE switches to a new TDD pattern from the set of TDD patterns received from the SIB(s), and if the configuration information of a considered symbol is different between the configuration received from the unicast message and the configuration of the new TDD pattern received from the SIB(s), the UE may be configured with a rule to handle the collision. In one example, a considered symbol may be configured as an uplink assignment by the unicast message, but the UE may switch to use a new TDD pattern (e.g. as described in 630 and/or 640) where the considered symbol is configured as a downlink assignment, resulting in a configuration collision between the configuration received from the unicast message and the configuration received from the SIB(s) for the considered symbol. In this case, as an example, the rule may indicate the UE to use the configuration from the new TDD pattern received from the SIB(s) for the considered symbol and, thus, the UE may consider the configuration from the unicast message as invalid for the considered symbol. As another example, the rule may indicate the UE to consider the considered symbol as reserved or flexible.

Indicating information that may be used to obtain and/or derive a set of TDD patterns may enable a network node and a UE to communicate in an NTN in a manner that mitigates resource waste, increased overhead signaling, and/or increased power consumption at a UE. For instance, the network node may indicate the set of TDD patterns in a single SIB to reduce signaling overhead, and the network node and/or the UE may sequentially apply two or more of the TDD patterns in the set in a coordinated manner (e.g., without additional signaling overhead). In some aspects, each TDD pattern in the set of TDD patterns may be associated with a respective application time such that the network node may assume when the UE will switch a TDD pattern, thus enabling the network node to allocate air interface resources that might otherwise not be used. In some aspects, the network node and the UE may switch the applied TDD pattern in a coordinated and simultaneous manner (e.g., without additional signaling overhead).

The use of a set of TDD patterns may also reduce how often the network node triggers an SI update procedure at the UE, thus reducing how often the UE receives and decodes the SIB to obtain updated TDD pattern information, and decrease power consumption at the UE. Reducing resource waste and signaling overhead may lead to decreased data transfer latencies and increased data throughput in a wireless network. Alternatively, or additionally, decreasing power consumption at a UE may extend an operating duration of the UE.

As indicated above, FIG. 6 is provided as an example. Other examples may differ from what is described with regard to FIG. 6.

FIG. 7 is a diagram illustrating an example process 700 performed, for example, at a UE or an apparatus of a UE, in accordance with the present disclosure. Example process 700 is an example where the apparatus or the UE (e.g., UE 120) performs operations associated with TDD in an NTN.

As shown in FIG. 7, in some aspects, process 700 may include receiving information that is associated with a set of TDD patterns that are associated with communicating in an NTN (block 710). For example, the UE (e.g., using reception component 902 and/or communication manager 906, depicted in FIG. 9) may receive information that is associated with a set of TDD patterns that are associated with communicating in an NTN, as described above.

As further shown in FIG. 7, in some aspects, process 700 may include communicating in the NTN based at least in part on using two or more TDD patterns in the set of TDD patterns in a sequential manner (block 720). For example, the UE (e.g., using reception component 902, transmission component 904, and/or communication manager 906, depicted in FIG. 9) may communicate in the NTN based at least in part on using two or more TDD patterns in the set of TDD patterns in a sequential manner, as described above.

Process 700 may include additional aspects, such as any single aspect or any combination of aspects described below and/or in connection with one or more other processes described elsewhere herein.

In a first aspect, the information includes the set of TDD patterns.

In a second aspect, the information indicates a configuration that is associated with deriving the set of TDD patterns using at least a latency.

In a third aspect, the latency is based at least in part on a distance between an uplink synchronization reference point, and a reference point that is indicated by a network node.

In a fourth aspect, process 700 includes receiving an indication of a TDD pattern time offset, and deriving an application time for using a TDD pattern in the set of TDD patterns, the application time being based at least in part on the TDD pattern time offset.

In a fifth aspect, the set of TDD patterns are based at least in part on a latency that is associated with an NTN communication beam, and a rate of change associated with the latency.

In a sixth aspect, process 700 includes receiving an indication of time information that indicates a respective application time for each TDD pattern in the set of TDD patterns.

In a seventh aspect, the time information is based at least in part on at least one of a global navigation satellite system, a coordinated universal time, or an NTN time partition.

In an eighth aspect, the information indicates the set of TDD patterns based at least in part on one or more delta TDD patterns.

In a ninth aspect, receiving the information that is associated with the set of TDD patterns includes receiving the information in a SIB.

In a tenth aspect, the SIB is a first SIB, and process 700 includes receiving a second SIB that indicates no change to an application of the set of TDD patterns.

In an eleventh aspect, the first SIB is associated with a tag value, and the second SIB indicates no change to the application of the set of TDD patterns based at least in part on the second SIB being associated with the tag value that is associated with the first SIB.

In a twelfth aspect, the SIB is a first SIB, and process 700 includes receiving a second SIB that indicates a change to an application of the set of TDD patterns.

In a thirteenth aspect, the first SIB is associated with a first tag value, and the second SIB indicates the change to the application of the set of TDD patterns based at least in part on the second SIB being associated with a second tag value.

In a fourteenth aspect, communicating in the NTN based at least in part on using the one or more TDD patterns in the set of TDD patterns includes using a first TDD pattern in the set of TDD patterns to communicate with a network node, switching to a second TDD pattern in the set of TDD patterns without receiving a message that indicates to switch to the second TDD pattern, and communicating with the network node using the second TDD pattern.

In a fifteenth aspect, the set of TDD patterns is a first set of TDD patterns, the first set of TDD patterns is associated with an expiration time, and process 700 includes switching from using the first set of TDD patterns to communicate in the NTN to using a second set of TDD patterns to communicate in the NTN based at least in part on the expiration time.

In a sixteenth aspect, process 700 includes receiving, in a unicast message, an indication of symbol resource configuration information, the symbol resource configuration information including at least a first symbol resource configuration that is associated with a first TDD pattern of the set of TDD patterns, and a second symbol resource configuration that is associated with a second TDD pattern of the set of TDD patterns.

In a seventeenth aspect, process 700 includes receiving an uplink grant, switching to using a particular TDD pattern indicated by the set of TDD patterns, and skipping an occasion of the uplink grant based at least in part on an incompatibility between the uplink grant and the particular TDD pattern.

In an eighteenth aspect, process 700 includes receiving an uplink grant, switching to using a particular TDD pattern indicated by the set of TDD patterns, and deactivating the uplink grant based at least in part on an incompatibility between the uplink grant and the particular TDD pattern.

In a nineteenth aspect, receiving the information that is associated with the set of TDD patterns includes receiving configuration information that indicates multiple potential configurations for the information that is associated with the set of TDD patterns, each potential configuration of the potential configurations being associated with one or more respective potential TDD patterns, and receiving a selection indication that selects a particular potential configuration of the multiple potential configurations.

In a twentieth aspect, communicating in the NTN based at least in part on using the two or more TDD patterns in the set of TDD patterns includes communicating in the NTN using a first TDD pattern in the set of TDD patterns, receiving a TDD pattern switch command message that indicates to use a second TDD pattern in the set of TDD patterns, and switching to using the second TDD pattern for communicating in the NTN based on the TDD pattern switch command message.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a network node or an apparatus of a network node, in accordance with the present disclosure. Example process 800 is an example where the apparatus or the network node (e.g., network node 110) performs operations associated with TDD in an NTN.

As shown in FIG. 8, in some aspects, process 800 may include transmitting information that is associated with a set of TDD patterns that are associated with communicating in an NTN (block 810). For example, the network node (e.g., using transmission component 1004 and/or communication manager 1006, depicted in FIG. 10) may transmit information that is associated with a set of TDD patterns that are associated with communicating in an NTN, as described above.

As further shown in FIG. 8, in some aspects, process 800 may include communicating in the NTN based at least in part on using two or more TDD patterns in the set of TDD patterns in a sequential manner (block 820). For example, the network node (e.g., using reception component 1002, transmission component 1004, and/or communication manager 1006, depicted in FIG. 10) may communicate in the NTN based at least in part on using two or more TDD patterns in the set of TDD patterns in a sequential manner, as described above.

Process 800 may include additional aspects, such as any single aspect or any combination of aspects described below and/or in connection with one or more other processes described elsewhere herein.

In a first aspect, the information includes the set of TDD patterns.

In a second aspect, the information indicates a configuration that is associated with deriving the set of TDD patterns using a latency.

In a third aspect, the latency is based at least in part on a distance between an uplink synchronization reference point, and a reference point.

In a fourth aspect, process 800 includes transmitting an indication of a TDD pattern time offset.

In a fifth aspect, the set of TDD patterns are based at least in part on a latency that is associated with an NTN communication beam, and a rate of change associated with the latency.

In a sixth aspect, process 800 includes transmitting an indication of time information that indicates a respective application time for each TDD pattern in the set of TDD patterns.

In a seventh aspect, the time information is based at least in part on at least one of a global navigation satellite system, a coordinated universal time, or an NTN time partition.

In an eighth aspect, the information indicates the set of TDD patterns based at least in part on one or more delta TDD patterns.

In a ninth aspect, transmitting the information that is associated with the set of TDD patterns includes transmitting the information in a SIB.

In a tenth aspect, the SIB is a first SIB, and process 800 includes transmitting a second SIB that indicates no change to an application of the set of TDD patterns.

In an eleventh aspect, the first SIB is associated with a tag value, and the second SIB indicates no change to the application of the set of TDD patterns based at least in part on the second SIB being associated with the tag value that is associated with the first SIB.

In a twelfth aspect, the SIB is a first SIB, and process 800 includes transmitting a second SIB that indicates a change to an application of the set of TDD patterns.

In a thirteenth aspect, the first SIB is associated with a first tag value, and the second SIB indicates the change to the application of the set of TDD patterns based at least in part on being associated with a second tag value.

In a fourteenth aspect, communicating in the NTN based at least in part on using the one or more TDD patterns in the set of TDD patterns includes using a first TDD pattern in the set of TDD patterns to communicate with a UE, switching to a second TDD pattern in the set of TDD patterns without transmitting an update message that indicates to update a TDD pattern, and communicating with the UE using the second TDD pattern.

In a fifteenth aspect, process 800 includes transmitting, in a unicast message, an indication of symbol resource configuration information, the symbol resource configuration information including at least a first symbol resource configuration that is associated with a first TDD pattern of the set of TDD patterns, and a second symbol resource configuration that is associated with a second TDD pattern of the set of TDD patterns.

In a sixteenth aspect, receiving the information that is associated with the set of TDD patterns includes transmitting configuration information that indicates multiple potential configurations for the information that is associated with the set of TDD patterns, each potential configuration of the potential configurations being associated with one or more respective potential TDD patterns, and transmitting a selection indication that selects a particular potential configuration of the multiple potential configurations.

In a seventeenth aspect, communicating in the NTN based at least in part on using the two or more TDD patterns in the set of TDD patterns includes communicating in the NTN using a first TDD pattern in the set of TDD patterns, transmitting a TDD pattern switch command message that indicates to use a second TDD pattern in the set of TDD patterns, and switching to using the second TDD pattern for communicating in the NTN based on the TDD pattern switch command message.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 140 described in connection with FIG. 1) of the UE.

In some aspects, the apparatus 900 may be configured to perform one or more operations described herein in connection with FIGS. 4-7. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the UE described above in connection with FIG. 1, such as a radio, one or more RF chains, one or more transceivers, or one or more modems, each of which may in turn be coupled with one or more antennas of the UE.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive information that is associated with a set of TDD patterns that are associated with communicating in an NTN. The reception component 902 and/or the transmission component 904 may communicate in the NTN based at least in part on using two or more TDD patterns in the set of TDD patterns in a sequential manner. Alternatively, or additionally, the reception component 902 may receive an indication of a TDD pattern time offset. In some aspects, the communication manager 906 may derive an application time for using a TDD pattern in the set of TDD patterns, the application time being based at least in part on the TDD pattern time offset.

The reception component 902 may receive an indication of time information that indicates a respective application time for each TDD pattern in the set of TDD patterns. Alternatively, or additionally, the reception component 902 may receive, in a unicast message, an indication of symbol resource configuration information, the symbol resource configuration information including at least a first symbol resource configuration that is associated with a first TDD pattern of the set of TDD patterns, and a second symbol resource configuration that is associated with a second TDD pattern of the set of TDD patterns.

The reception component 902 may receive an uplink grant. The communication manager 906 may switch to using a particular TDD pattern indicated by the set of TDD patterns. Alternatively, or additionally, the communication manager 906 may skip an occasion of the uplink grant based at least in part on an incompatibility between the uplink grant and the particular TDD pattern. In other aspects, the communication manager 906 may deactivate the uplink grant based at least in part on an incompatibility between the uplink grant and the particular TDD pattern.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node, or a network node may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 155 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 4-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The transmission component 1004 may transmit information that is associated with a set of TDD patterns that are associated with communicating in an NTN. The reception component 1002 and/or the transmission component 1004 may communicate in the NTN based at least in part on using two or more TDD patterns in the set of TDD patterns in a sequential manner. Alternatively, or additionally, the transmission component 1004 may transmit an indication of a TDD pattern time offset.

In some aspects, the transmission component 1004 may transmit an indication of time information that indicates a respective application time for each TDD pattern in the set of TDD patterns. Alternatively, or additionally, the transmission component 1004 may transmit, in a unicast message, an indication of symbol resource configuration information, the symbol resource configuration information including at least a first symbol resource configuration that is associated with a first TDD pattern of the set of TDD patterns, and a second symbol resource configuration that is associated with a second TDD pattern of the set of TDD patterns.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving information that is associated with a set of time division duplex (TDD) patterns that are associated with communicating in a non-terrestrial network (NTN); and communicating in the NTN based at least in part on using two or more TDD patterns in the set of TDD patterns in a sequential manner.

Aspect 2: The method of Aspect 1, wherein the information comprises the set of TDD patterns.

Aspect 3: The method of any of Aspects 1-2, wherein the information indicates a configuration that is associated with deriving the set of TDD patterns using at least a latency.

Aspect 4: The method of Aspect 3, wherein the latency is based at least in part on a distance between: an uplink synchronization reference point, and a reference point that is indicated by a network node.

Aspect 5: The method of any of Aspects 1-4, further comprising: receiving an indication of a TDD pattern time offset; and deriving an application time for using a TDD pattern in the set of TDD patterns, the application time being based at least in part on the TDD pattern time offset.

Aspect 6: The method of any of Aspects 1-5, wherein the set of TDD patterns are based at least in part on: a latency that is associated with an NTN communication beam, and a rate of change associated with the latency.

Aspect 7: The method of any of Aspects 1-6, further comprising: receiving an indication of time information that indicates a respective application time for each TDD pattern in the set of TDD patterns.

Aspect 8: The method of Aspect 7, wherein the time information is based at least in part on at least one of: a global navigation satellite system, a coordinated universal time, or an NTN time partition.

Aspect 9: The method of any of Aspects 1-8, wherein the information indicates the set of TDD patterns based at least in part on one or more delta TDD patterns.

Aspect 10: The method of any of Aspects 1-9, wherein receiving the information that is associated with the set of TDD patterns comprises: receiving the information in a system information block (SIB).

Aspect 11: The method of Aspect 10, wherein the SIB is a first SIB, and wherein the method further comprises: receiving a second SIB that indicates no change to an application of the set of TDD patterns.

Aspect 12: The method of Aspect 11, wherein the first SIB is associated with a tag value, and wherein the second SIB indicates no change to the application of the set of TDD patterns based at least in part on the second SIB being associated with the tag value that is associated with the first SIB.

Aspect 13: The method of Aspect 10, wherein the SIB is a first SIB, and wherein the method further comprises: receiving a second SIB that indicates a change to an application of the set of TDD patterns.

Aspect 14: The method of Aspect 13, wherein the first SIB is associated with a first tag value, and wherein the second SIB indicates the change to the application of the set of TDD patterns based at least in part on the second SIB being associated with a second tag value.

Aspect 15: The method of any of Aspects 1-14, wherein communicating in the NTN based at least in part on using the one or more TDD patterns in the set of TDD patterns comprises: using a first TDD pattern in the set of TDD patterns to communicate with a network node; switching to a second TDD pattern in the set of TDD patterns without receiving a message that indicates to switch to the second TDD pattern; and communicating with the network node using the second TDD pattern.

Aspect 16: The method of any of Aspects 1-15, wherein the set of TDD patterns is a first set of TDD patterns, wherein the first set of TDD patterns is associated with an expiration time, and wherein the method further comprises: switching from using the first set of TDD patterns to communicate in the NTN to using a second set of TDD patterns to communicate in the NTN based at least in part on the expiration time.

Aspect 17: The method of any of Aspects 1-16, further comprising: receiving, in a unicast message, an indication of symbol resource configuration information, the symbol resource configuration information comprising at least: a first symbol resource configuration that is associated with a first TDD pattern of the set of TDD patterns, and a second symbol resource configuration that is associated with a second TDD pattern of the set of TDD patterns.

Aspect 18: The method of any of Aspects 1-17 further comprising: receiving an uplink grant; switching to using a particular TDD pattern indicated by the set of TDD patterns; and skipping an occasion of the uplink grant based at least in part on an incompatibility between the uplink grant and the particular TDD pattern.

Aspect 19: The method of any of Aspects 1-18 further comprising: receiving an uplink grant; switching to using a particular TDD pattern indicated by the set of TDD patterns; and deactivating the uplink grant based at least in part on an incompatibility between the uplink grant and the particular TDD pattern.

Aspect 20: The method of any of Aspects 1-19, wherein receiving the information that is associated with the set of TDD patterns comprises: receiving configuration information that indicates multiple potential configurations for the information that is associated with the set of TDD patterns, each potential configuration of the potential configurations being associated with one or more respective potential TDD patterns; and receiving a selection indication that selects a particular potential configuration of the multiple potential configurations.

Aspect 21: The method of any of Aspects 1-20, wherein communicating in the NTN based at least in part on using the two or more TDD patterns in the set of TDD patterns comprises: communicating in the NTN using a first TDD pattern in the set of TDD patterns; receiving a TDD pattern switch command message that indicates to use a second TDD pattern in the set of TDD patterns; and switching to using the second TDD pattern for communicating in the NTN based on the TDD pattern switch command message.

Aspect 22: A method of wireless communication performed by a network node, comprising: transmitting information that is associated with a set of time division duplex (TDD) patterns that are associated with communicating in a non-terrestrial network (NTN); and communicating in the NTN based at least in part on using two or more TDD patterns in the set of TDD patterns in a sequential manner.

Aspect 23: The method of Aspect 22, wherein the information comprises the set of TDD patterns.

Aspect 24: The method of any of Aspects 22-23, wherein the information indicates a configuration that is associated with deriving the set of TDD patterns using a latency.

Aspect 25: The method of Aspect 24, wherein the latency is based at least in part on a distance between: an uplink synchronization reference point, and a reference point.

Aspect 26: The method of any of Aspects 22-25, further comprising: transmitting an indication of a TDD pattern time offset.

Aspect 27: The method of any of Aspects 22-26, wherein the set of TDD patterns are based at least in part on: a latency that is associated with an NTN communication beam, and a rate of change associated with the latency.

Aspect 28: The method of any of Aspects 22-27, further comprising: transmitting an indication of time information that indicates a respective application time for each TDD pattern in the set of TDD patterns.

Aspect 29: The method of Aspect 28, wherein the time information is based at least in part on at least one of: a global navigation satellite system, a coordinated universal time, or an NTN time partition.

Aspect 30: The method of any of Aspects 22-29, wherein the information indicates the set of TDD patterns based at least in part on one or more delta TDD patterns.

Aspect 31: The method of any of Aspects 22-30, wherein transmitting the information that is associated with the set of TDD patterns comprises: transmitting the information in a system information block (SIB).

Aspect 32: The method of Aspect 31, wherein the SIB is a first SIB, and wherein the method further comprises: transmitting a second SIB that indicates no change to an application of the set of TDD patterns.

Aspect 33: The method of Aspect 32, wherein the first SIB is associated with a tag value, and wherein the second SIB indicates no change to the application of the set of TDD patterns based at least in part on the second SIB being associated with the tag value that is associated with the first SIB.

Aspect 34: The method of Aspect 31, wherein the SIB is a first SIB, and wherein the method further comprises: transmitting a second SIB that indicates a change to an application of the set of TDD patterns.

Aspect 35: The method of Aspect 34, wherein the first SIB is associated with a first tag value, and wherein the second SIB indicates the change to the application of the set of TDD patterns based at least in part on being associated with a second tag value.

Aspect 36: The method of any of Aspects 22-35, wherein communicating in the NTN based at least in part on using the one or more TDD patterns in the set of TDD patterns comprises: using a first TDD pattern in the set of TDD patterns to communicate with a user equipment (UE); switching to a second TDD pattern in the set of TDD patterns without transmitting an update message that indicates to update a TDD pattern; and communicating with the UE using the second TDD pattern.

Aspect 37: The method of any of Aspects 22-36, further comprising: transmitting, in a unicast message, an indication of symbol resource configuration information, the symbol resource configuration information comprising at least: a first symbol resource configuration that is associated with a first TDD pattern of the set of TDD patterns, and a second symbol resource configuration that is associated with a second TDD pattern of the set of TDD patterns.

Aspect 38: The method of any of Aspects 22-37, wherein receiving the information that is associated with the set of TDD patterns comprises: transmitting configuration information that indicates multiple potential configurations for the information that is associated with the set of TDD patterns, each potential configuration of the potential configurations being associated with one or more respective potential TDD patterns; and transmitting a selection indication that selects a particular potential configuration of the multiple potential configurations.

Aspect 39: The method of any of Aspects 22-38, wherein communicating in the NTN based at least in part on using the two or more TDD patterns in the set of TDD patterns comprises: communicating in the NTN using a first TDD pattern in the set of TDD patterns; transmitting a TDD pattern switch command message that indicates to use a second TDD pattern in the set of TDD patterns; and switching to using the second TDD pattern for communicating in the NTN based on the TDD pattern switch command message.

Aspect 40: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-21.

Aspect 41: An apparatus for wireless communication at a device, the apparatus comprising one or more memories and one or more processors coupled to the one or more memories, the one or more processors configured to cause the device to perform the method of one or more of Aspects 1-21.

Aspect 42: An apparatus for wireless communication, the apparatus comprising at least one means for performing the method of one or more of Aspects 1-21.

Aspect 43: A non-transitory computer-readable medium storing code for wireless communication, the code comprising instructions executable by one or more processors to perform the method of one or more of Aspects 1-21.

Aspect 44: A non-transitory computer-readable medium storing a set of instructions for wireless communication, the set of instructions comprising one or more instructions that, when executed by one or more processors of a device, cause the device to perform the method of one or more of Aspects 1-21.

Aspect 45: A device for wireless communication, the device comprising a processing system that includes one or more processors and one or more memories coupled with the one or more processors, the processing system configured to cause the device to perform the method of one or more of Aspects 1-21.

Aspect 46: An apparatus for wireless communication at a device, the apparatus comprising one or more memories and one or more processors coupled to the one or more memories, the one or more processors individually or collectively configured to cause the device to perform the method of one or more of Aspects 1-21.

Aspect 47: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 22-39.

Aspect 48: An apparatus for wireless communication at a device, the apparatus comprising one or more memories and one or more processors coupled to the one or more memories, the one or more processors configured to cause the device to perform the method of one or more of Aspects 22-39.

Aspect 49: An apparatus for wireless communication, the apparatus comprising at least one means for performing the method of one or more of Aspects 22-39.

Aspect 50: A non-transitory computer-readable medium storing code for wireless communication, the code comprising instructions executable by one or more processors to perform the method of one or more of Aspects 22-39.

Aspect 51: A non-transitory computer-readable medium storing a set of instructions for wireless communication, the set of instructions comprising one or more instructions that, when executed by one or more processors of a device, cause the device to perform the method of one or more of Aspects 22-39.

Aspect 52: A device for wireless communication, the device comprising a processing system that includes one or more processors and one or more memories coupled with the one or more processors, the processing system configured to cause the device to perform the method of one or more of Aspects 22-39.

Aspect 53: An apparatus for wireless communication at a device, the apparatus comprising one or more memories and one or more processors coupled to the one or more memories, the one or more processors individually or collectively configured to cause the device to perform the method of one or more of Aspects 22-39.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a +b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive information that is associated with a set of time division duplex (TDD) patterns that are associated with communicating in a non-terrestrial network (NTN); and
communicate in the NTN based at least in part on using two or more TDD patterns in the set of TDD patterns in a sequential manner.

2. The apparatus of claim 1, wherein the information comprises the set of TDD patterns.

3. The apparatus of claim 1, wherein the information indicates a configuration that is associated with deriving the set of TDD patterns using at least a latency.

4. The apparatus of claim 1, wherein the one or more processors are further configured to cause the UE to:
receive an indication of a TDD pattern time offset; and
derive an application time for using a TDD pattern in the set of TDD patterns, the application time being based at least in part on the TDD pattern time offset.

5. The apparatus of claim 1, wherein the set of TDD patterns are based at least in part on:
a latency that is associated with an NTN communication beam, and
a rate of change associated with the latency.

6. The apparatus of claim 1, wherein the one or more processors are further configured to cause the UE to:
receive an indication of time information that indicates a respective application time for each TDD pattern in the set of TDD patterns.

7. The apparatus of claim 1, wherein the information indicates the set of TDD patterns based at least in part on one or more delta TDD patterns.

8. The apparatus of claim 1, wherein the one or more processors, to cause the UE to receive the information that is associated with the set of TDD patterns, are configured to cause the UE to:
receive the information in a system information block (SIB).

9. The apparatus of claim 1, wherein the one or more processors, to cause the UE to communicate in the NTN based at least in part on using the one or more TDD patterns in the set of TDD patterns, are configured to cause the UE to:
use a first TDD pattern in the set of TDD patterns to communicate with a network node;
switch to a second TDD pattern in the set of TDD patterns without receiving a message that indicates to switch to the second TDD pattern; and
communicate with the network node using the second TDD pattern.

10. The apparatus of claim 1, wherein the set of TDD patterns is a first set of TDD patterns,
wherein the first set of TDD patterns is associated with an expiration time, and
wherein the one or more processors are further configured to cause the UE to:
switch from using the first set of TDD patterns to communicate in the NTN to using a second set of TDD patterns to communicate in the NTN based at least in part on the expiration time.

11. The apparatus of claim 1, wherein the one or more processors, to cause the UE to receive the information that is associated with the set of TDD patterns, are configured to cause the UE to:
receive configuration information that indicates multiple potential configurations for the information that is associated with the set of TDD patterns, each potential configuration of the potential configurations being associated with one or more respective potential TDD patterns; and
receive a selection indication that selects a particular potential configuration of the multiple potential configurations.

12. The apparatus of claim 1, wherein the one or more processors, to cause the UE to communicate in the NTN based at least in part on using the two or more TDD patterns in the set of TDD patterns, are configured to cause the UE to:
communicate in the NTN using a first TDD pattern in the set of TDD patterns;
receive a TDD pattern switch command message that indicates to use a second TDD pattern in the set of TDD patterns; and
switch to using the second TDD pattern for communicating in the NTN based on the TDD pattern switch command message.

13. A method of wireless communication performed by a user equipment (UE), comprising:
receiving information that is associated with a set of time division duplex (TDD) patterns that are associated with communicating in a non-terrestrial network (NTN); and
communicating in the NTN based at least in part on using two or more TDD patterns in the set of TDD patterns in a sequential manner.

14. The method of claim 13, further comprising:
receiving an indication of a TDD pattern time offset; and
deriving an application time for using a TDD pattern in the set of TDD patterns, the application time being based at least in part on the TDD pattern time offset.

15. The method of claim 13, further comprising:
receiving an indication of time information that indicates a respective application time for each TDD pattern in the set of TDD patterns.

16. The method of claim 13, wherein the information indicates the set of TDD patterns based at least in part on one or more delta TDD patterns.

17. The method of claim 13, wherein receiving the information that is associated with the set of TDD patterns comprises:
receiving the information in a system information block (SIB).

18. The method of claim 13, wherein communicating in the NTN based at least in part on using the one or more TDD patterns in the set of TDD patterns comprises:
using a first TDD pattern in the set of TDD patterns to communicate with a network node;
switching to a second TDD pattern in the set of TDD patterns without receiving a message indicates to switch to the second TDD pattern; and
communicating with the network node using the second TDD pattern.

19. The method of claim 13, further comprising:
receiving an uplink grant;
switching to using a particular TDD pattern indicated by the set of TDD patterns; and
skipping an occasion of the uplink grant based at least in part on an incompatibility between the uplink grant and the particular TDD pattern.

20. A non-transitory computer-readable medium storing a set of instructions for wireless communication, the set of instructions comprising:
one or more instructions that, when executed by one or more processors of a user equipment (UE), cause the UE to:
receive information that is associated with a set of time division duplex (TDD) patterns that are associated with communicating in a non-terrestrial network (NTN); and
communicate in the NTN based at least in part on using two or more TDD patterns in the set of TDD patterns in a sequential manner.
